(19) United States
(12) Patent Application Publication
(10) Pub. No.: US 2020/0197950 A1
(43) Pub. Date: Jun. 25, 2020

(54) ULTRASONIC TREATMENT OF MINED SAND PROPPANT FOR HYDRAULIC FRACTURE TREATMENT IN THE OIL/GAS INDUSTRY AND CLEANED QUARTZ SOURCE FOR THE GLASS INDUSTRY

(71) Applicant: Michael Lee Fraim, Corrales, NM (US)

(72) Inventor: Michael Lee Fraim, Corrales, NM (US)

(21) Appl. No.: 16/225,734

(22) Filed: Dec. 19, 2018

(51) Int. Cl. B03B 9/02; B06B 1/02; B06B 1/06; B06B 1/08; C09K 8/80

(52) U.S. Cl. CPC B03B 9/02; B06B 1/0223; B06B 1/0688; B06B 2201/71; C09K 8/805; B06B 2201/56; B06B 2201/58; B06B 1/08

(57) ABSTRACT

A process for the ultrasonic treatment of mined sand proppant for hydraulic fracture treatment, the process comprising the steps of pumping sand particles in an aqueous fluid to an ultrasonic device operating at a suitable frequency and a suitable power range. The sand particles remain at a proximity to the ultrasonic device for a first predetermined period of time to remove contaminants from the sand particles.

### FIELD

The embodiments relate to a system and process for the removal of non-quartz solid material that is adhered to or coating the quartz/silica/corundum sand grains to improve purity and mechanical strength properties.

### BACKGROUND

Ultrasonic energy has been used since 1967 to clean and deburr metal machined parts. Usually, water or low volatility oil is used as the liquid medium to carry abrasive and create cavitation. Ultrasonic energy has been utilized in a solvent bath to remove bitumen from tar sand. Tar sand needs to fluidize by stirring to reduce the treatment time and prevent supersaturation of the solvent with dissolved bitumen. High-intensity ultrasonic cavitation in aqueous surfactant has been employed to remove the bitumen coating from the tar sands. Further, ultrasonic cavitation has been used in a water bath to remove carbonized binder coating on used foundry mold sand. A lobed rod is used to fluidize the sand mixture and encourage self-grinding of binder off sand particle surface by physical abrasion.

The prior art has also used ultrasonic energy to bond metallic parts such as chips onto a circuit board. Friction is used to cause localized heating and removal of oxide coating to bond the metallic surfaces together.

Previously, ultrasonic energy has been used to shot peen gas turbine components to prevent distortions of curved machined parts during heat up or cool down of the component. Ultrasonic shot peening can cold forge tiny fractures closed in repaired turbine blades. Ultrasonic shot peening treats the surface more uniform than jet assisted shot blasting because the shot hit the target surface from random directions instead of perpendicular to the surface.

In other examples, ultrasonic energy is used to degas liquids by creating cavitation in the liquid while heating the liquid to near boiling point. Cavitation in aqueous solutions has been shown to remove fluorocarbon compounds by degrading them to carbon dioxide and hydrofluoric acid. In another example, ultrasonic energy has been used to enhance leaching of uranium from ore in an acid bath.

Ultrasonic energy has also been provided in an acid bath to enhance the removal of cobalt metal binder from a polycrystalline diamond element surface for enhanced thermal stability during operation. Ultrasonic energy and electric discharge pulses have been used to enhance ore leaching and leached metal reaction rate with carbon dioxide gas.

Ultrasonic cavitation has been used to stress relieve very thin metal parts such as magnetic recording heads while cleaning the surface from lapping compounds. The stress relief allows the metal arm to remain flat as the hard disk heats up during heavy read and write operations.

### SUMMARY OF THE INVENTION

Embodiments disclosed herein relate to a process for the ultrasonic treatment of mined sand proppant for hydraulic fracture treatment, the process comprising the steps of pumping sand particles in an aqueous fluid to an ultrasonic device operating at a suitable frequency and a suitable power range. The sand particles remain at a proximity to the ultrasonic device for a first predetermined period of time to remove contaminants from the sand particles. This process operates to improve the mechanical strength of the sand particles for their use in the oil, glass, or abrasive industries.

In one aspect, the suitable frequency is between 8-20 kHz, the suitable power range is between 10-150 watts per cubic centimeter, and the first predetermined period of time is between 2-60 seconds.

In one aspect, the process further comprises the steps of transferring the pure sand particles at 5-20% by volume through a second ultrasonic device having a frequency between 20-40 kHz. The second ultrasonic device may have a power range between 10-200 watts per cubic centimeter. The pure sand particles are retained at a sufficient proximity to the ultrasonic device for a second predetermined period of time to peen, polish, and smooth the surfaces of the pure sand particles.

In one aspect, the second predetermined period of time is between 10-120 seconds.

In one aspect, the sand particles are pumped through a closed channel flow reactor with one or more magneto-restrictive transducers with a frequency range of 8-30 kHz.

In another aspect, the sand particles are pumped through a closed channel flow reactor with one or more piezo-electric ultrasonic transducers with a range of 30 kHz to 2 MHz.

In one aspect, the ultrasonic device is a tank with a paddle mixer and a submersible ultrasonic device with one or more magneto restrictive transducers or one or more piezoelectric transducers.

In another aspect, the ultrasonic device is a pipe or a tank including a power probe ultrasonic source with one or more magneto restrictive transducers or one or more piezoelectric transducers.

In one aspect, the process further comprises the step of hard-facing the sand particles with a resin or a ceramic coating to increase the compressive strength of the sand particles.

In one aspect, the step of hard-facing with a ceramic coating further includes the step of reducing the sand particle surface with carbon or nitrogen to produce silica carbide, silica nitride, or alumina nitride, which is catalyzed with iron, boron, or calcium salt.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a schematic of the relative sound intensity, ultrasonic treatment zones, and mechanical type of magneto restrictive transducer focusing, according to some embodiments;

FIG. 2 illustrates the basic closed channel forms with measured intense cavitation zones from the disintegration of metal foils, according to some embodiments;

FIG. 3 illustrates the basic closed channel forms with measured intense cavitation zones from the disintegration of metal foils, according to some embodiments;

FIG. 4 illustrates the ultrasonic power probe designs for attrition of non-quartz minerals from the quartz grains, according to some embodiments;

FIG. 5A illustrates the flow through a channel for a quad frequency reactor, according to some embodiments;

FIG. 5B illustrates the flow through a channel for a quad frequency reactor, according to some embodiments;

FIG. 6 illustrates a scanning electron microscope (SEM) average image of a 20-mesh quartz sand particle surface after ultrasonic treatment for rounding, ultrasonic peening, and ultrasonic etching, according to some embodiments;

FIG. 7 illustrates the flow through a slot for the dual frequency reactor, according to some embodiments;

FIG. 8A illustrates a side elevation view of the hard-facing oven with the ultrasonic lobed probe peening, according to some embodiments;

FIG. 8B illustrates a top plan view of the hard-facing oven with the ultrasonic lobed probe peening, according to some embodiments;

FIG. 9 illustrates a flowchart of the sand proppant treatment process, according to some embodiments; and

FIG. 10 illustrates a flowchart of the abrasive treatment process, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments; it is noted that the embodiments reside primarily in combinations of components related to the system and process. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As shown in the above examples, there is a lack of technology for ultrasonic cleaning of sand-sized particles coated with natural carbonate and sulfate salts and for the ultrasonic hard facing of sand-sized particles after cleaning by ultrasonic peening in a slurry. For oversized sand-sized particles, ultrasonic energy is used to enhance the etching of particle surface to reduce its size. For understrength particles, the ultrasonic cleaning micro etches the particle surface to improve resin or ceramic coating adherence.

The present invention uses a lower frequency (8-20 kHz) ultrasonic source to create large cavitation bubbles in an aqueous liquid to shatter or erode lower strength material from the quartz grain surface. Then, to improve mechanical strength, a higher frequency (20-80 kHz) ultrasonic source is used to generate tiny cavitation bubbles to smooth and polish surface roughness of the cleaned quartz sand grain.

The non-quartz material or mineral contaminant can be naturally occurring such as clay, calcium or magnesium carbonate, iron oxide, feldspar, in addition to barium and strontium sulfate minerals. The materials associated with the quartz grains depend on the geological location of the mine.

The objective of the ultrasonic treatment is to remove the non-quartz material, suspend said material in the aqueous fluid and separate pure quartz grains from a fluid with mechanical separation such as a hydro-cyclone and/or mechanical screen. An additional washing step is performed on the vibrating mechanical screen to remove any residual clay particles adhered to quartz grain to reduce any fines migration in the final installed sand pack.

In some embodiments, natural sand size particles are prepared for use in the oil and gas industry, glass industry, or in the abrasive industry. Particles used as a proppant in the oil and gas industry must have a roundness factor over 0.7 and a roughness factor over 0.7 to withstand the high compressive loads of closure pressure in human-made fractures in the reservoir rock. Spherical shaped and cylindrical particles have the highest strength to volume ratio. Particles for the glass industry must be 99.9% pure to receive maximum value for the raw product. Particles used for abrasives must have a roundness factor over 0.7 and a roughness factor less than 0.6 to have enough edges to cut metal or ceramic. Thin sharp edge particles cannot withstand the heat and shear force from grinding or sandblasting with an air jet.

The main use of ultrasonic energy is to near perfectly remove natural sandstone cements such as calcium carbonate, magnesium carbonate, calcium sulfate, magnesium sulfate, iron oxide, and iron sulfate from the quartz or corundum particles. During compression of naturally coated particles, the cement coating fractures and generates fines that plug the remaining pore space and restricts fluid flow or generates excessive dust during sandblasting. The glass industry needs pure quartz product, so the generated glass is clear and not off-specification color.

After the natural cements are removed from the sand-size particles, the whole particle surface is ultrasonically peening to put the surface in compression. Other technologies such as air jet blasting on a solid target or rolling between plates do not treat the full surface of a non-round particle, thereby reducing the particle crush and impact strength. Ultrasonic peening also leaves the surface slightly wave rough, so the particle has higher slip friction.

Since the natural sand-sized particles are mined, there will be a significant number of particles that are oversized. Conventional grinding will fracture the surface of the particle. Ultrasonic grinding, along with etching agents such as sodium or potassium hydroxide, will greatly enhance material removal without fracturing the remaining volume of the particle. These processed particles may have a roundness factor over 0.85 due to even material removal in an ultrasonic cavitation field.

Some batches of processed sand may test understrength due to the natural variation of the composition of the impure quartz or corundum. This understrength sand batch is coated with a resin or boro-alumina-calcium silicate hydroxide and then heated to 200-400 C to set the resin or dehydrate the boro-alumina-calcium to the solid phase.

The sludge containing clay and natural cement removed from sand can also contain oxidized heavy metals such as iron and barium. The iron oxide or barium sulfate in the sludge can have value for the weighting agents in mud for the oil drilling and oil cement industry. Ultrasound and a chelating agent or nitric acid can be used to leach the heavy metals from the sludge to produce a leach liquor. The leach liquor will be neutralized with sodium hydroxide and the heavy metal oxide, or hydroxide precipitate will be recovered for a separate product line.

The ultrasonic cleaning and ultrasonic peening process are the same for the abrasive manufacture. The curing of the ceramic coating is different and requires longer treatment times, and a higher temperature range from 800-1700 C. The silicate molecule is changed to a silica nitride or silica carbide molecule on the surface to greatly improve the compressive strength and hardness of the surface.

In some embodiments, magneto restrictive transducers are used for ultrasonic treatment frequencies from about 8 kHz to 30 kHz. Piezoelectric transducers are used for ultrasonic treatment frequencies from about 30 kHz to 100 kHz to clean naturally occurring cement from the sand-sized particle (200 mesh to 8 mesh) surfaces and to peen the sand size particle surface so that the particle surface is in a compression state. This embodiment concentrates on closed ultrasonic treatment channels for industrially rated treatment volumes of solid sand-sized particles for the oil and gas industry, bulk abrasives for tool building, and high strength ceramic nano-particles for high impact applications such as sandblasting or military armor. Special small batch processes can be performed in an ultrasonic bath with submersible transducers.

For megasonic frequencies from 350 kHz to 2 MHz, the piezoelectric transducer generates a Fraunhofer zone immediately. The cleaning or coating technique is through free radical generation at power levels above 0.6 W/cc in the carrier fluid for reactions with particle surface. The free radicals can include hydroxyl radial from water molecule which makes hydrogen peroxide in the bulk aqueous phase which will oxide free iron ion to ferrous ion and if excess hydrogen peroxide is available then ferrous ion is oxidized to a ferric ion which subsequently precipitates as ferric silicate on silica particles. The treated fluid is delivered by acoustic streaming from the transducer surface into the bulk fluid in the channel.

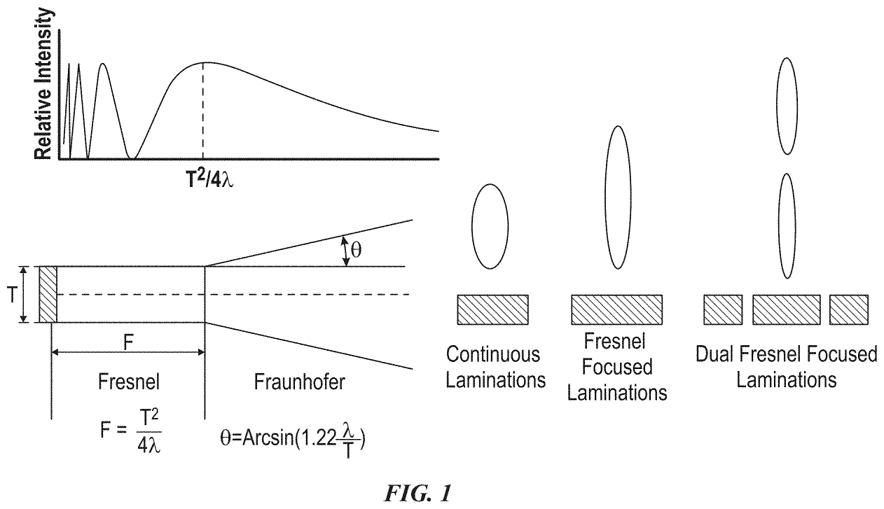

FIG. 1 shows the acoustic energy intensity and intense cavitation, “hot,” spot pattern produced by magneto restrictive transducers. The Fresnel zone is where ultrasonic transmission from individual ultrasonic lamination sources produces constructive and destructive interference. The Fresnel zone transitions to the Fraunhofer zone at the square of transducer width divided by the 4 times the wavelength of transmitted ultrasound. The Fraunhofer zone is where the individual sources of the transducer have combined into a plane wave that decays with length traveled in the fluid. The Fraunhofer spread angle of decay is related to the arcsin of the ratio of wavelength to transducer width. Also shown is “intense cavitation zone” for continuously stacked laminations, Fresnel focused laminations, and dual Fresnel focused laminations. Continuously stacked laminations are best for channel widths less 1.5 wavelengths, Fresnel focused laminations are best for channel widths less than 2.5 wavelengths, and dual Fresnel focused laminations are for channel widths up to 5 wavelengths. Power piezoelectric transducers are electronically Fresnel focused.

Mechanical Fresnel focused magneto restrictive transducers are used for channel widths greater than 1 wavelength in width or depth. For ultrasonic frequencies above 30 kHz, an electrically focused piezoelectric transducer is used for the treating material in the channel. For treating sand-sized particles below 80 mesh, the ultrasonic transducer frequency is increased down the channel to clean Nano-sized residual cement off the sand-sized particle surface.

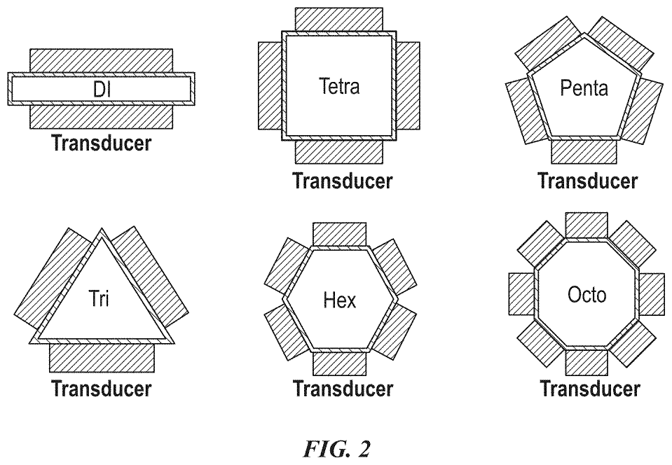

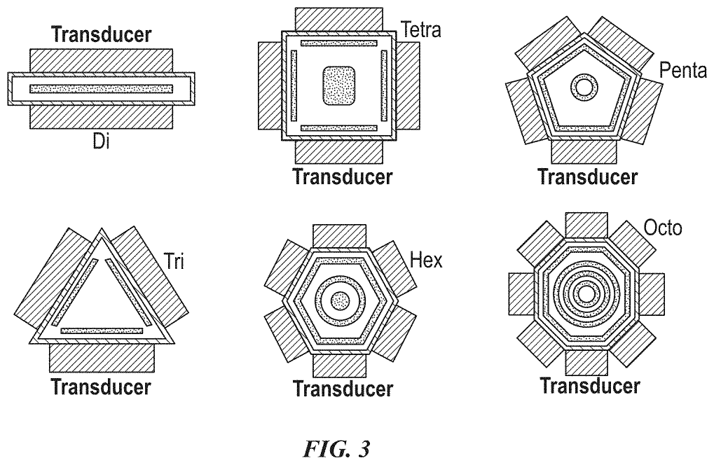

FIG. 2 shows the basic closed channel shapes of di, tri, tetra, penta, hex, and octo sides. FIG. 3 shows the basic intense cavitation or “hot” zones that were measured by the disintegration of metal foils along the center line of the transducer arrangement. One skilled in the arts will appreciate that additional embodiments of the closed flow channel design can be utilized.

The di-transducer channel is specifically designed for two frequency interference in the Fresnel treatment zone for incredibly rapid, random pressure changes in the channel for disaggregation or disintegration of solid product by ultrasonic cavitation. The primary ultrasonic transducer frequency can range from 8 kHz to 22 kHz, and the secondary, opposing ultrasonic transducer will have an offset of 2, 3, 4, 6 kHz depending on the application. The channel width to height ratio can range from 1 to 4 to 1 to 40 depending on the application and power required per volume to grind the product. The slot channel shape is used because the grinding action attenuates the ultrasonic energy very quickly away from the active surface. As solid volume and cavitation increase, the destructive interference prevents generation of a planer wavefront in the Fraunhofer zone. The ultrasonic frequency and slot height to width ratio can increase downstream in the reactor to grind product to even smaller particles.

The di-transducer channel is designed for two frequency interference in the Fresnel treatment zone for incredibly rapid, random pressure changes in the channel for disaggregation or disintegration of solid product by ultrasonic cavitation.

The di-transducer ultrasonic processing channel 700, as shown in FIG. 7, is specially adapted at the disintegration of ore or stone along grain boundaries and sealed natural fractures where heavy metals precipitated as the brine supersaturated in the natural fracture or pore system in the ore. This ultrasonic processing can also fluidize shale/clay streaks in sandstone. The ultrasonic frequency and optimal slot width are chosen to shatter cement, remove shale lens and natural fracture gouge in the ore or stone with minimum surface wear of the intact grains. The inset picture shows an aluminum foil disintegration pattern where black represents complete removal.

The tri-transducer channel is designed for the mechanical concentration of the ultrasonic energy in the Fraunhofer zone with no standing wave generation. It has a very uniform ultrasonic treatment field. The shape causes super intense mixing of fluid in each corner which in turn causes intense eddy mixing of the main body of fluid.

The tetra-transducer channel is designed for intense standing wave reflection in the Fraunhofer zone between walls to generate constructive and destructive interference in the body of the fluid flow in the channel. The intense cavitation zone in the center of the channel is more uniform throughout channel volume in this shape.

The penta-transducer channel is for intense ultrasonic energy in the Fraunhofer zone with no standing wave generation. This shape only has a small intense cavitation zone in the center.

The hex-transducer channel is specifically designed for intense standing wave reflection in the Fraunhofer zone between walls to generate constructive and destructive interference in the body of the fluid flow in the channel. This is the first shape to uniformly concentrate ultrasonic cavitation zones in ring shapes in the center of the channel. The six transducers will generate harmonic frequencies at 1, 2, and 4 kHz offsets to generate near random cavitation from all sizes of a sand-sized particle.

The octo-transducer channel is specifically designed for intense standing wave reflection in the Fraunhofer zone between walls to generate constructive and destructive interference in the body of the fluid flow in the channel. This is the optimum shape to radially concentrate ultrasonic Fraunhofer cavitation in the center of the channel with multiple intense cavitation ring zones. The eight transducers will generate harmonic frequencies at 1, 2, 4 and 8 kHz offsets to generate near random cavitation field from all sizes of even a tiny clay-sized particle.

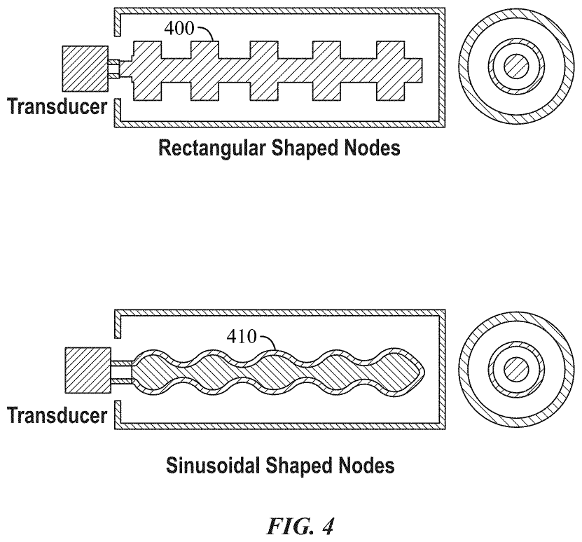

For extra heavy-duty fracturing of polycrystalline quartz particles or removal of barite scale coating on quartz particles, the annular ultrasonic probe treatment channels are used and are shown in FIG. 4. The rectangular edged nodes 400 are for large cavitation required grain-to-probe surface impact to fracture polycrystalline quartz phase particles. The sinusoidally shaped nodes 410 are for coating removal such as barium scale on sand particles. The particles roll and bounce along the upstream part of the node 400,410, which causes the scale coating to fracture. The probe rods have a high wear rate compared to the surface of the closed-channel ultrasonic process, but this physical impact process is more effective at removal of non-quartz mineral removal from the quartz grain.

In some embodiments which include the di-transducer ultrasonic processing channel, the pumped ore/stone slurry to be treated should contain less than 50% solids by volume and the initial clod size should be less than slot height to prevent plugging and wall abrasion. For crushed angular particle shapes, the solids volume should not exceed 30% solids by volume to prevent wall abrasion damage. The magnetite particles are removed from the reactor wall to prevent wall abrasion damage with a polymer sweep while the transducers are turned off. The dual frequencies are offset by 1-4 kHz, such as 8 & 10 kHz or 16 & 20 kHz. The chelating agent is used to tie up heavy metals that should not be disposed in the clay-sized sludge. A surfactant can be used to increase the surface tension of the aqueous phase that is used for cavitation. Not shown is the electrochemical cell to precipitate the heavy metals on the cathode surface to recycle the chelating agent.

As stated above, the tri-transducer channel is designed for the mechanical concentration of the ultrasonic energy in the Fraunhofer zone with no standing wave generation. It has a very uniform ultrasonic treatment field. The shape causes super intense mixing of fluid in each corner which in turn causes intense eddy mixing of the main body of fluid. Further, the primary ultrasonic transducer frequency can range from 8 kHz to 22 kHz, and the two-secondary ultrasonic transducers will have an offset of 2, 3, 4, 6 kHz depending on the application and an offset of at least 2 kHz between them. This ultrasonic process can be used for uniform peening of sand-sized particles and micro-etching particles for resin or ceramic coating.

The tetra-transducer channel is specifically designed for intense standing wave reflection in the Fraunhofer zone between walls to generate constructive and destructive interference in the body of the fluid flow in the channel. The intense cavitation zone in the center of the channel is more uniform throughout channel volume in this shape. The channel width to height ratio can range from 1 to 1 to 1 to 2 depending on the application. For channel widths above 1 wavelength, magneto restrictive transducers will use Fresnel focusing. The two primary ultrasonic transducers frequencies can range from 8 kHz to 22 kHz, the two-secondary ultrasonic transducers will have an offset of 2, 3, 4, 6 kHz depending on the application and an offset of at least 2 kHz between any of the transducers. The ultrasonic frequency can increase with each set of 4 transducers along the channel. Above 35 kHz frequency, piezoelectric transducers are used to generate ultrasound up to 100 kHz frequency. The tetra-transducer design has slightly less ultrasonic power per volume than the di-transducer design. Therefore the tetra-transducer design will need a longer channel length to achieve the same disintegration particle size as the di-transducer design.

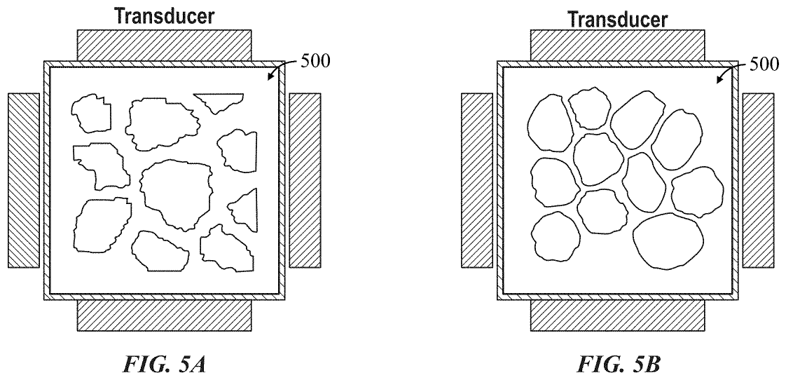

FIG. 5A and FIG. 5 B illustrates a typical flow through a channel 500 for a quad frequency reactor of the embodiment. The channel 500 width to height ratio can range from 1 to 1 to 1 to 2 depending on the application. For channel widths above 1 wavelength, magneto restrictive transducers will use Fresnel focusing. The ultrasonic frequency can increase with each set of 4 transducers. Above 35 kHz frequency, piezoelectric transducers are used to generate ultrasound up to 100 kHz frequency.

The tetra-transducer ultrasonic applications shown in FIG. 5A and FIG. 5B is for heavy duty cleaning of naturally calcite-cemented sandstone and for removal of ankerite cement from “red bed” sandstone. For ultrasonic cement removal and dissolution of precipitated metal oxides off particle surface, typically treats a slurry with less than 10% by volume solids through the closed channel to prevent supersaturation of chelating agent and destructive Fresnel interference of the particles themselves on Fraunhofer plane wave generation in the center of the channel. To prevent abrasive wear of the channel walls, the channel is usually mounted with an angle greater than 35 degrees, so the sand-sized particles will not settle to one side and increase the solids volume ratio above 21%. The inset picture of rectangularly shaped nodes 400 in FIG. 4 shows crushed sandstone that the natural cement coating is being removed and the edges are being rounded. The quad frequencies are offset between 2-4 kHz, such as 20, 22, 24, & 28 kHz or 18, 22, 26, & 28 kHz configurations. Experience shows the next set of ultrasonic transducers in the tetra-channel should increase between 2-3 kHz.

The tetra-transducer ultrasonic peening typically treats more than 40% by volume solids, but less than 70% by volume solids through the closed channel after the product has been ultrasonically cleaned and sieved. The high solids content and proper ultrasonic frequency and power can use the particles to peen each other without breakage. The channel can be in horizontal or vertical position. The ultrasonic peening occurs when the sand particles bounce off the channel walls or bounce off each other. The inset picture of sinusoidally shaped nodes 410 in FIG. 4 shows rounded sandstone that is being peened to put the particle surface in compression. Coatings of resin or silicate salt can be added after the peening process to increase strength and smoothness. The quad frequencies are offset between 2-4 kHz, such as 20, 22, 24, & 28 kHz or 18, 22, 26, & 28 kHz configurations. Experience shows the next set of ultrasonic transducers in the tetra-channel should increase around 4 kHz.

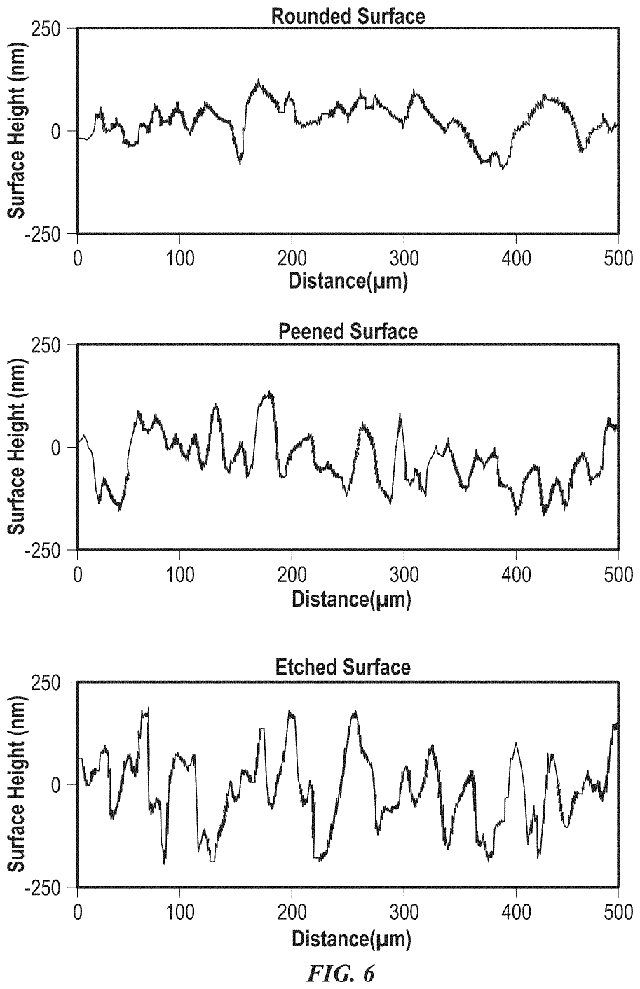

FIG. 6 shows a typical scanning electron microscope (SEM) average image of a 20-mesh quartz sand particle surface after ultrasonic treatment for rounding, ultrasonic peening and ultrasonic etching with the tetra-transducer ultrasonic channel.

The magnetite particles are removed from the reactor wall to prevent wall abrasion damage with a polymer sweep while the transducers are turned off. A chelating agent is used to tie up heavy metals that should not be disposed in the clay-sized sludge. A surfactant can be used to increase the surface tension of the aqueous phase that is used for cleaning and cavitation.

The penta-transducer channel is for intense ultrasonic energy in the Fraunhofer zone with no standing wave generation. This shape only has a small intense cavitation zone in the center and has similar performance as the tri-transducer design with no solid product build-up end the edges. The primary ultrasonic transducer frequency can range from 8 kHz to 22 kHz, and the four-secondary ultrasonic transducers will have an offset of 2, 3, 4 kHz depending on the application and an offset of at least 2 kHz between them. This ultrasonic process can be used for uniform peening of sand-sized particles.

The hex-transducer channel is specifically designed for intense standing wave reflection in the Fraunhofer zone between walls to generate constructive and destructive interference in the body of the fluid flow in the channel. This is the first shape to uniformly concentrate ultrasonic cavitation zones in ring shapes in the center of the channel. The six transducers with 1, 2, 3 and 4 kHz offsets will generate harmonic frequencies that create near random cavitation from all sizes of a sand-sized particle. This ultrasonic process design is optimal for leaching/etching heavy metals from grain boundaries with the chelating agent and shaping a near round sand sized particle product. The SEM image of an etched quartz surface is shown in FIG. 6.

The octo-transducer channel is specifically designed for intense standing wave reflection in the Fraunhofer zone between walls to generate constructive and destructive interference in the body of the fluid flow in the channel. This is the optimum shape designed to radially concentrate ultrasonic Fraunhofer cavitation in the center of the channel with multiple rings of intense cavitation. The eight transducers with 1, 2, 3 and 4 kHz offsets will generate harmonic frequencies that create near random cavitation field from all sizes of even tiny clay-sized particles. This ultrasonic process design is optimal for peening surface for coating with resin or ceramic using a bonding agent for a ceramic or wetting agent for the resin. The SEM image of a peened quartz surface is shown in FIG. 6.

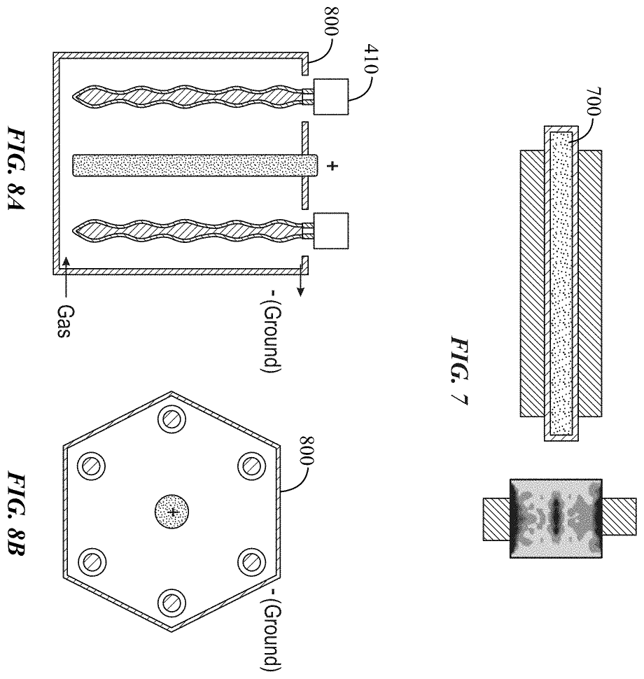

FIG. 8A shows a side view A-A′ and FIG. 8B shows the top view of an abrasive hard-facing oven 800 with ultrasonic lobed probe peening. The pulsed DC electrodes are shown as + and—in the image and are used to generate the plasma from the gas to react with the surface of the sand particle. The amplitude of the pulse should be at least 2,000 volts and less than 10,000 volts. The pulse width should be between 0.1 seconds to 2 seconds. The lobed bar is used to distribute ultrasonic energy into the bulk fluid/granular solid in the closed channel. Each lobe on the bar takes between 5-10% of the energy traveling down or the same for the reflected energy traveling up the bar. This lobed probe design distributes acoustic energy along the active surface of the probe channel for uniform hard facing treatment of granular material in the channel by constantly rotating the sand grains in the channel.

Ammonia, methane, propane, cyanide, and borohydride can be used as gases to generate the plasma to react with the sand particle surface. Iron and aluminum chloride coating can be used to catalyze the silica nitride conversion at a lower temperature. Carbon black can be mixed with the sand to catalyze the carbothermal reduction of silicate to silicon then conversion to silica nitride.

FIG. 8B shows a top view of an ultrasonic enhanced hard-facing oven 800 with the pulsed DC electrode in the center and the ground return on the outside. The lobed ultrasonic probes 410 (as shown in FIG. 8A) provide the peening force to yield the surface of the hard-facing such as silica carbide or silica nitride for quartz sand particles without shattering the sand grain itself during the plasma diffusion process. The oven temperature should range from 700 C to 1400 C depending on the diffusion time and compression stress required in the hard-faced coating.

### Example 1

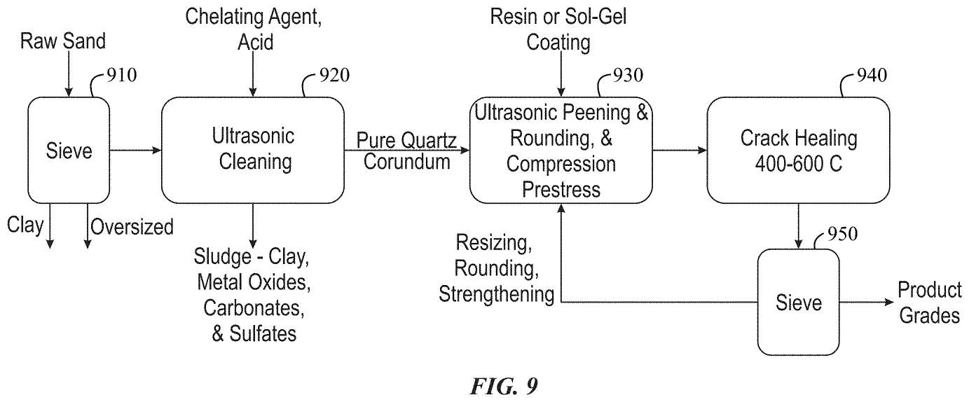

FIG. 9 shows a typical sand proppant and clean quart particle treatment process, according to some embodiments. The crushed sandstone, river sand, or dune sand is sieved in step 910 to remove the undersized clay and the oversized gravel. For sand proppant, the useful particle size distribution is moved to the ultrasonic cleaning bath at step 920. If the coating on the sand particles is contaminated with heavy metal elements, then a chelating agent is added to prevent precipitation with the sludge. An electrochemical cell (not shown) is used to precipitate the heavy metal on the cathode and return the chelating agent back to the process. Oversized and undersized quartz is clean and shipped to the glass factory or used for builder's sand.

After cleaning and in step 930, the sand size particles are moved to the ultrasonic peening process for rounding the particle shape and adding compression prestress to the surface of the particle. For understrength sand particles, a sol-gel coating can be spray coated as the particles are continuously removed from the bath and then heated with hot air as particles drop off the belt. The heating process heals cracks in the natural sand grains at step 940.

After cooling down and in step 950, the particles are sieved for final product grades, and quality tested to verify strength, roundness, and roughness for each batch of sand processed. For low strength sand particles batches, the ultrasonic peening and coating process is repeated.

### Example 2

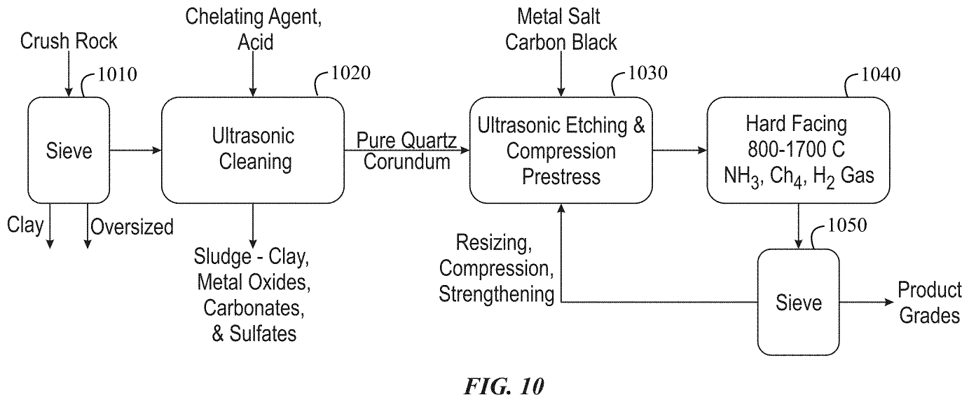

FIG. 10 shows a typical abrasive or ceramic proppant treatment process, according to some embodiments. In step 1010, the crushed sandstone, river sand, or dune sand is sieved to remove the undersized clay and the oversized gravel. The oversized material is crushed and then re-sieved. The useful particle size distribution is moved to the ultrasonic cleaning bath in step 1020. If the sand coating is contaminated with heavy metal elements, then a chelating agent is added to prevent precipitation with the sludge. An electrochemical cell (not shown) is used to precipitate the heavy metal on the cathode and return the chelating agent back to the process.

For understrength sand or impure corundum particles, a liquid film or powered metal salt such an iron, tungsten, boron, or aluminum is coated on the particle. If a carbide metal salt is desired for final ceramic, then carbon black can be added to the coating prior to ultrasonic etching in step 1030.

In step 1040, the coated particles are heat treated with a plasma gas to set the coating and complete the carbonization or nitrogenating reaction of the metal coating on the particle. The ratio of carbide to nitride is controlled by treatment time and the ratio of ammonia to methane gases.

Particles are rapidly cooled to put the outer coating in compression as they leave the oven. Undersized and undercoated particles are returned to the ultrasonic etching bath (step 1030) to receive an additional coating. Ultrasonic peening of the final product will put the silica carbide, aluminum nitride or silica nitride coating in compression, but this is usually done for high impact applications such as armor plating composites. In step 1050, the particles are sieved.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A process for the ultrasonic treatment of mined sand proppant for hydraulic fracture treatment, the process comprising the steps of:
pumping sand particles in an aqueous fluid to an ultrasonic device operating at a suitable frequency and a suitable power range, the sand particles remaining at a proximity to the ultrasonic device for a first predetermined period of time to remove contaminants from the sand particles.

2. The process of claim 1, wherein the suitable frequency is between 8-20 kHz.

3. The process of claim 1, wherein the suitable power range is between 10-150 watts per cubic centimeter.

4. The process of claim 1, wherein the first predetermined period of time is between 2-60 seconds.

5. The process of claim 1, further comprising the steps of transferring the pure sand particles at 5-20% by volume through a second ultrasonic device having a frequency between 20-40 kHz, the second ultrasonic device having a power range between 10-200 watts per cubic centimeter, the pure sand particles remaining at a sufficient proximity to the ultrasonic device for a second predetermined period of time to peen, polish, and smooth the surfaces of the pure sand particles.

6. The process of claim 5, wherein the second predetermined period of time is between 10-120 seconds.

7. The process of claim 5, wherein the sand particles are pumped through a closed channel flow reactor with one or more magneto-restrictive transducers with a frequency range of 8-30 kHz.

8. The process of claim 5, wherein the sand particles are pumped through a closed channel flow reactor with one or more piezo-electric ultrasonic transducers with a range of 30 kHz to 2 MHz.

9. The process of claim 5, wherein the ultrasonic device is a tank with a paddle mixer and a submersible source with one or more magneto restrictive transducers or one or more piezoelectric transducers.

10. The process of claim 5, wherein the ultrasonic device is a pipe or a tank including a power probe source with one or more magneto restrictive transducers or one or more piezoelectric transducers.

11. The process of claim 5, further comprising the step of hard-facing the sand particles with a resin or a ceramic coating to increase the compressive strength of the sand particles.

12. The process of claim 11, wherein the step of hard-facing with a ceramic coating includes the step of reducing the sand particle surface with carbon or nitrogen to produce silica carbide, silica nitride, or alumina nitride, wherein the silica carbide, silica nitride, or alumina nitride is catalyzed with iron, boron, or calcium salt.

13. A process for the ultrasonic treatment of mined sand proppant for hydraulic fracture treatment, the process comprising the steps of:
pumping sand particles in an aqueous fluid through or around an ultrasonic device having a frequency between 8-20 kHz, the ultrasonic device having a power range between 10-150 watts per cubic centimeter, the sand particles remaining at a sufficient proximity to the ultrasonic device for a first predetermined period of time to remove non-quartz, non-alumina, or non-silica material from the sand particles to produce pure sand particles;
transferring the pure sand particles at 5-20% by volume through a second ultrasonic device having a frequency between 20-40 kHz, the second ultrasonic device having a power range between 10-200 watts per cubic centimeter, the pure sand particles remaining at a sufficient proximity to the ultrasonic device for a second predetermined period of time to peen, polish, and smooth the surfaces of the pure sand particles.

14. The process of claim 13, wherein the first predetermined period of time is between 2-60 seconds.

15. The process of claim 13, wherein the second predetermined period of time is between 10-120 seconds.

16. The process of claim 13, wherein the sand particles are pumped through a closed channel flow reactor with one or more piezo-electric ultrasonic transducers with a range of 30 kHz to 2 MHz, or wherein the sand particles are pumped through a closed channel flow reactor with one or more magneto-restrictive transducers with a frequency range of 8-30 kHz.

17. The process of claim 13, wherein the ultrasonic device is a tank with a paddle mixer and a submersible source with one or more magneto restrictive transducers or one or more piezoelectric transducers.

18. The process of claim 13, wherein the ultrasonic device is a pipe or a tank including a power probe source with one or more magneto restrictive transducers or one or more piezoelectric transducers.

19. The process of claim 13, further comprising the step of hard-facing the sand particles with a resin or a ceramic coating to increase the compressive strength of the sand particles.

20. The process of claim 19, wherein the step of hard-facing with a ceramic coating includes the step of reducing the sand particle surface with carbon or nitrogen to produce silica carbide, silica nitride, or alumina nitride, wherein the silica carbide, silica nitride, or alumina nitride is catalyzed with iron, boron, or calcium salt.
